(19) United States
(12) Patent Application Publication
(10) Pub. No.: US 2025/0062056 A1
(43) Pub. Date: Feb. 20, 2025

(54) GROMMET

(71) Applicant: YAZAKI CORPORATION, Tokyo (JP)

(72) Inventors: Hirotaka Kiyota, Makinohara-shi (JP); Takeshi Onoda, Makinohara-shi (JP)

(21) Appl. No.: 18/935,404

(22) Filed: Nov. 1, 2024

Related U.S. Application Data
(63) Continuation of application No. PCT/JP2023/036660, filed on Oct. 10, 2023.

(30) Foreign Application Priority Data
Nov. 14, 2022 (JP) 2022-181555

(51) Int. Cl. H01B 17/58; B60R 16/02

(52) U.S. Cl. CPC H01B 17/583; B60R 16/0222

(57) ABSTRACT

A water stop member includes an annular main body that is coaxially brought into contact with an annular wall surface on a circumference portion side of a through-hole of a flange of a base member, an annular outer circumferential lip that is protruded toward the circumference portion, bend-deforms at the attachment completion position, and is brought into close contact with an annular plane of the circumference portion over one circumference, and an annular inner circumferential lip protruded toward the circumference portion in such a manner as to get closer to a hole axis of the through-hole as coaxially getting closer to the circumference portion from an inner circumference portion side than the outer circumferential lip of the main body, bend-deforms at the attachment completion position, and is brought into close contact with the annular plane side of the circumference portion over one circumference.

### CROSS-REFERENCE TO RELATED APPLICATION

This application is a continuation application of International Application No. PCT/JP2023/036660 filed on Oct. 10, 2023 which claims the benefit of priority from Japanese Patent Application No. 2022-181555 filed on Nov. 14, 2022 and designating the U.S., the entire contents of which are incorporated herein by reference.

### BACKGROUND OF THE INVENTION

### 1. Field of the Invention

The present invention relates to a grommet.

### 2. Description of the Related Art

Conventionally, in a wiring harness, by inserting a wiring member such as an electric wire into a through-hole provided in an insertion target object (for example, a panel of a vehicle body in a vehicle, or the like), the wiring member is drawn in from one space partitioned by this insertion target object, to a different space. Thus, in order to protect the wiring member from the circumference of the through-hole, and prevent the entry of liquid into a clearance gap between the through-hole and the wiring member, a grommet blocking the clearance gap is attached to the insertion target object. For example, the grommet is formed of a base member made of hard synthetic resin material, and an annular water stop member made of a flexible synthetic resin material such as rubber, and is inserted into the through-hole, whereby the water stop member is brought into close contact with the circumference of the through-hole in the insertion target object. For example, Japanese Patent Application Laid-open No. 8-251769 described below discloses a grommet formed in this manner.

On the other hand, in a conventional grommet, in order to improve waterproofness between the water stop member and the circumference of the through-hole, an annular lip is sometimes provided on the water stop member. This lip is protruded in an insertion direction into the through-hole in the grommet, and when the grommet is assembled to the circumference of the through-hole, it is brought into contact with the circumference and stick it while bending. Thus, in the grommet of this type, the lip causes an increase in insertion force toward the through-hole.

### SUMMARY OF THE INVENTION

In view of the foregoing, the object of the present invention is to provide a grommet that can reduce insertion force.

In order to achieve the above mentioned object, a grommet according to one aspect of the present invention includes: a base member that is made of synthetic resin material, and inserts a conductive wiring member laid from one space to a different space through a through-hole of an insertion target object, thereinside; and an annular grommet main body arranged in the one space at an attachment completion position to a circumference portion of the through-hole of the insertion target object, by being assembled to the base member, wherein the base member includes an annular flange that is arranged in the one space at the attachment completion position, and coaxially arranged to face an annular plane on the one space side of the annular circumference portion with a clearance gap, and a cylindrical portion coaxially protruded from the flange toward the different space, and inserted into the through-hole at the attachment completion position, and a plurality of engagement portions protruded from an outer circumferential surface of the cylindrical portion in the different space at the attachment completion position, and brought into contact with the circumference portion from the different space side in the different space at the attachment completion position, in a circumferential direction of the cylindrical portion, the grommet main body includes an annular water stop member made of elastically deformable synthetic resin material softer than the base member, the water stop member includes an annular main body that is coaxially brought into contact with an annular wall surface on the circumference portion side of the flange, an annular outer circumferential lip that is protruded toward the circumference portion in such a manner as to be separated from a hole axis of the through-hole as coaxially getting closer to the circumference portion from the main body, bend-deforms at the attachment completion position, and is brought into close contact with the annular plane of the circumference portion over one circumference, and an annular inner circumferential lip that is protruded toward the circumference portion in such a manner as to get closer to the hole axis of the through-hole as coaxially getting closer to the circumference portion from an inner circumference portion side than the outer circumferential lip of the main body, bend-deforms at the attachment completion position, and is brought into close contact with the annular plane side of the circumference portion over one circumference, and the inner circumferential lip includes a bend-deformable thin portion on its leading end side, the thin portion into close contact with the annular plane side of the circumference portion by bend-deforming the thin portion at the attachment completion position.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view illustrating a grommet of an embodiment that is attached to an insertion target object;

FIG. 2 is a plan view illustrating a grommet of an embodiment that is attached to an insertion target object and viewed from a cylindrical portion side;

FIG. 3 is a plan view illustrating a grommet of an embodiment that is attached to an insertion target object and viewed from a tubular portion side;

FIG. 4 is a diagram illustrating an X-X line cross section in FIG. 2;

FIG. 5 is a perspective view illustrating a grommet of an embodiment that is unattached to an insertion target object and viewed from another angle;

FIG. 6 is a diagram corresponding to the X-X line cross section in FIG. 2, and illustrates a state caused before attachment to an insertion target object;

FIG. 7 is an exploded perspective view illustrating a grommet of an embodiment;

FIG. 8 is an exploded perspective view illustrating a grommet of an embodiment viewed from another angle;

FIG. 9 is an exploded perspective view separately illustrating two base members and a grommet main body that are attached to a grommet of an embodiment;

FIG. 10 is an exploded perspective view of a base member and a waterproof member; and

FIG. 11 is an exploded perspective view of a grommet main body.

### DETAILED DESCRIPTION OF THE PREFERRED EMBODIMENTS

A grommet according to an embodiment of the present invention will be described in detail below based on the drawings. In addition, the present invention is not limited by the embodiment.

### EMBODIMENT

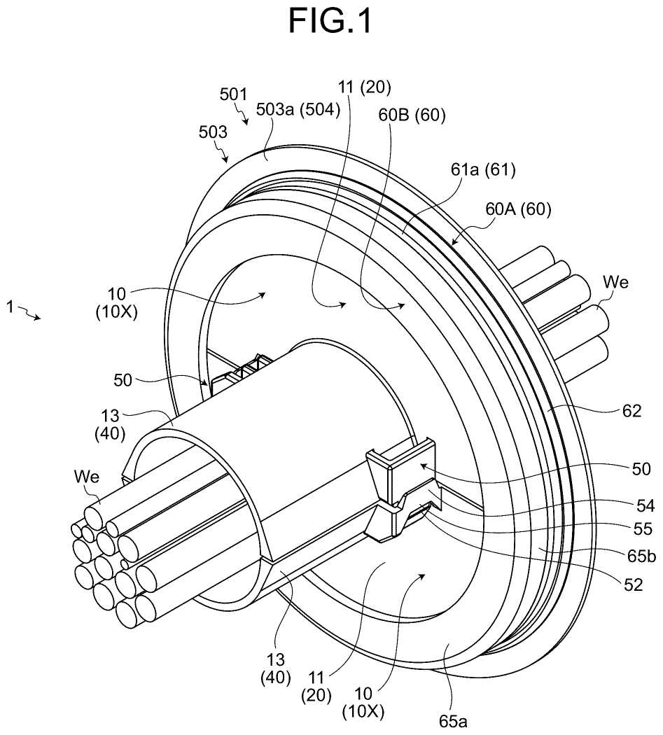

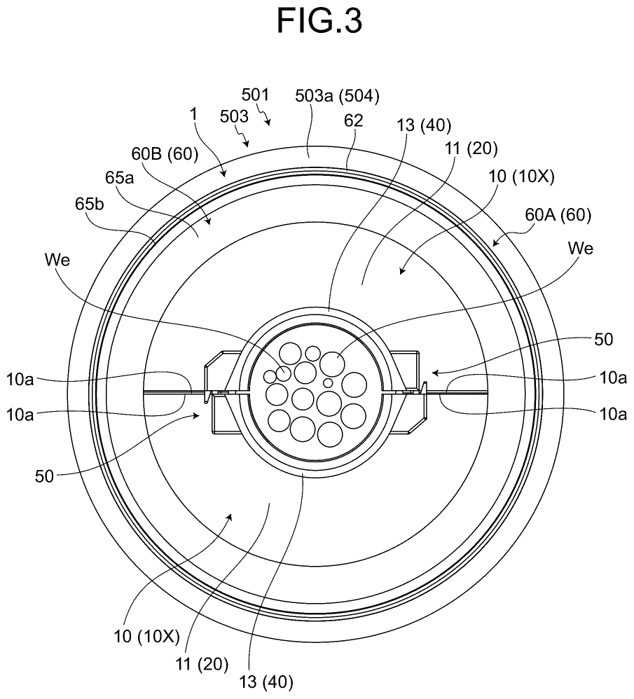

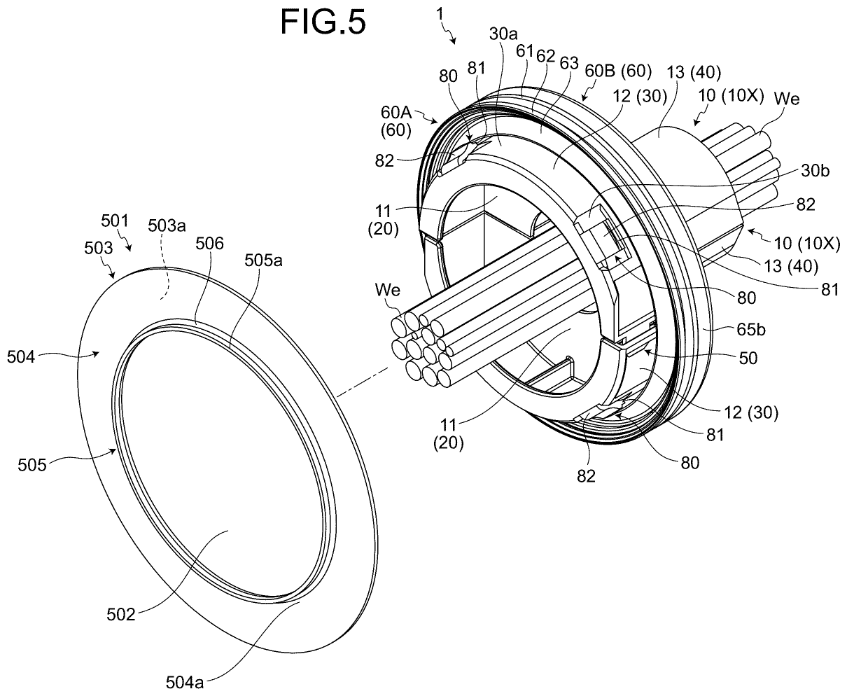

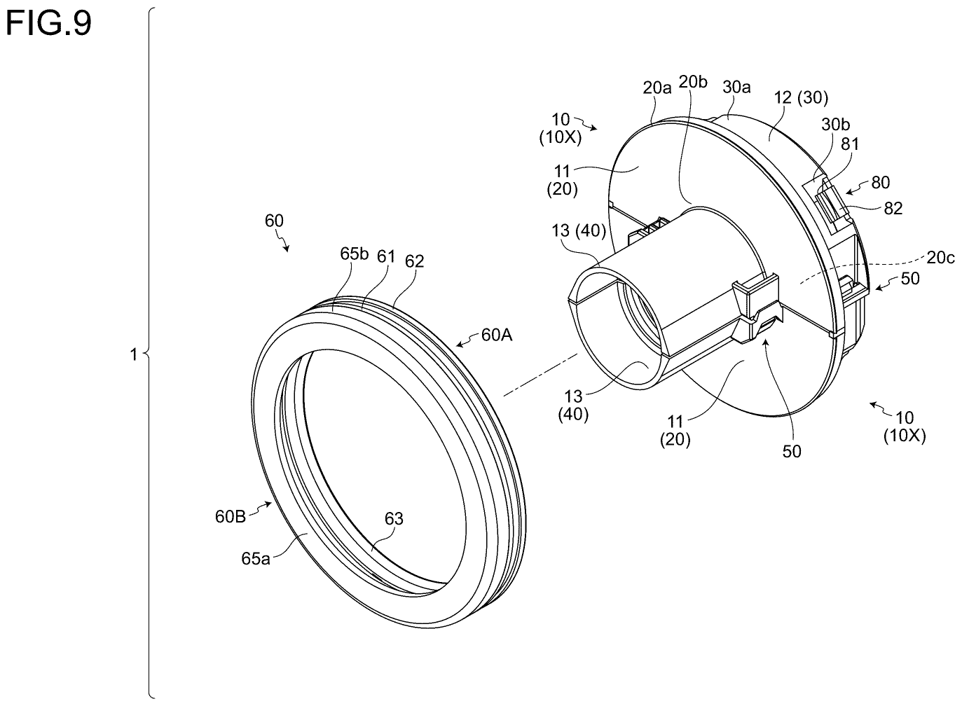

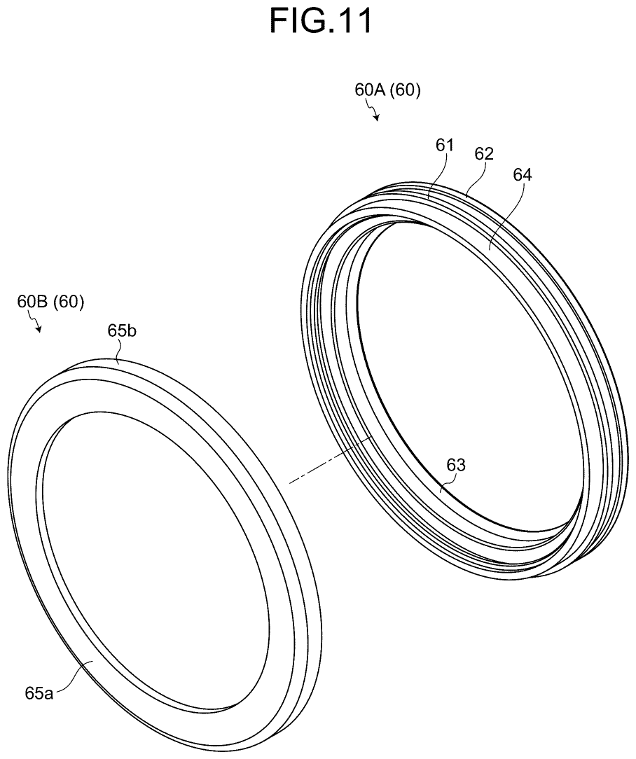

One of grommets according to the present invention will be described based on FIGS. 1 to 11.

A sign 1 in FIGS. 1 to 9 denotes a grommet of the present embodiment. The grommet 1 protects a conductive the wiring member We laid from one space S1 to a different space S2 through a through-hole 502 of an insertion target object 501, from a circumference portion 503 of the through-hole 502 in the insertion target object 501, and prevents the entry of liquid (water, etc.) into a clearance gap between the annular circumference portion 503 and the wiring member We (FIGS. 1 to 6). Therefore, the grommet 1 is attached to the circumference portion 503 of the through-hole 502 of the insertion target object 501 after the insertion of the wiring member We.

Here, the wiring member We refers to, for example, an electric wire (an electric wire serving as a communication wire, an electric wire serving as a power wire, or the like). In addition, the insertion target object 501 is a member for inserting the wiring member We, and refers to a wall member such as a panel of a vehicle body in the case of a vehicle, for example. By being inserted into the through-hole 502 of the insertion target object 501, the wiring member We is laid between the one space S1 and the different space S2 partitioned by the insertion target object 501. For example, the wiring member We undertakes a role of communication between apparatuses of the one space S1 and the different space S2, and undertakes a role of power supply or the like from a power source of the different space S2 to an electric device in the one space S1.

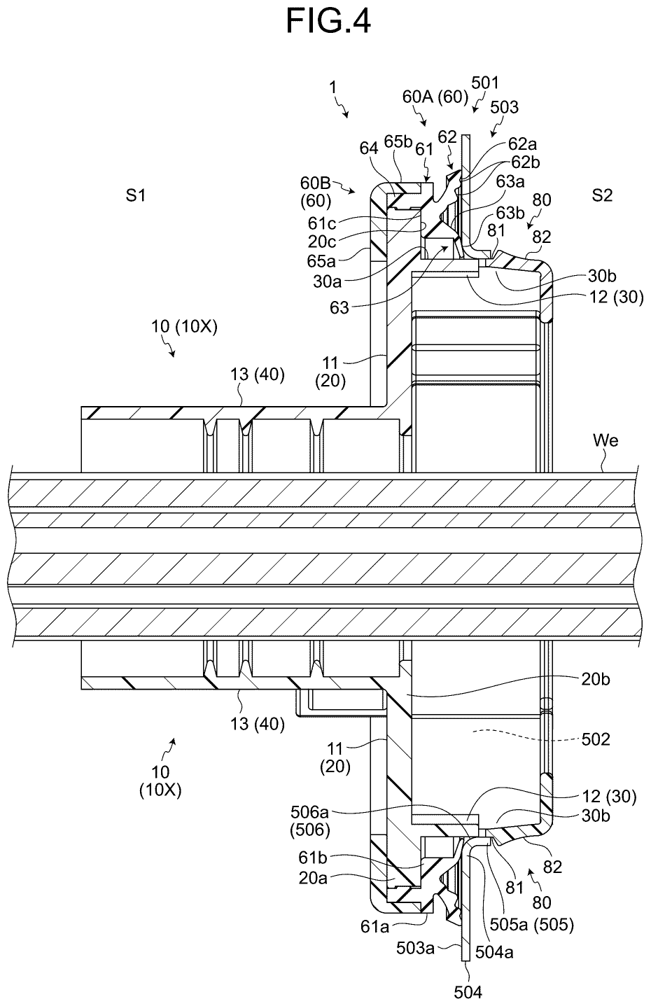

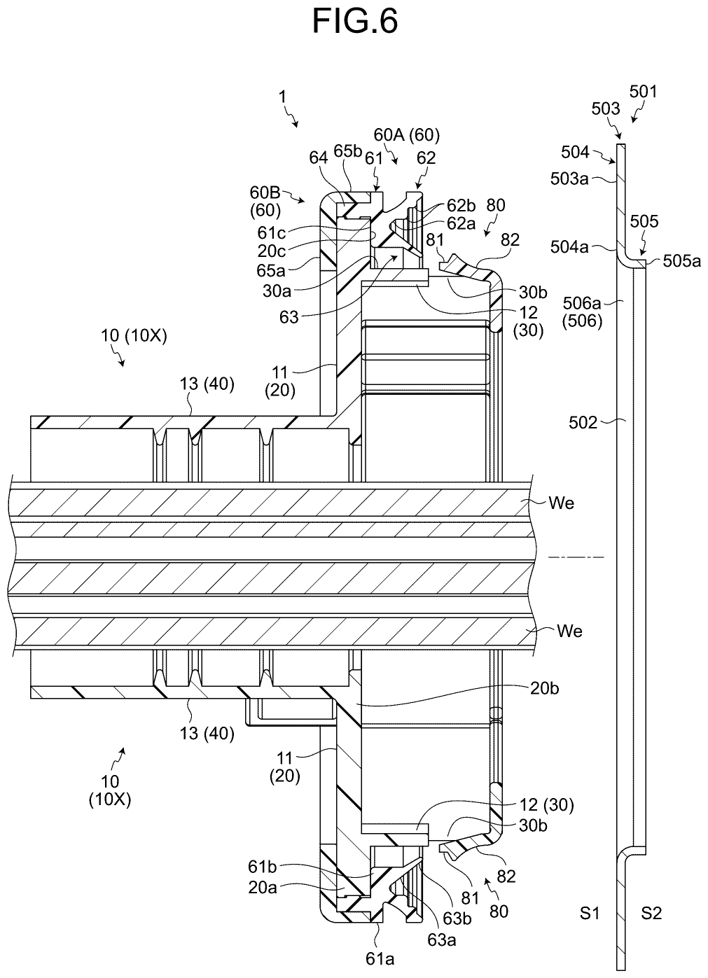

The circumference portion 503 of the through-hole 502 of the insertion target object 501 includes an annular flat panel portion (hereinafter, will be referred to as a “annular flat panel portion”.) 504, and an annular protruding portion (hereinafter, will be referred to as a “annular protruding portion”.) 505 (FIGS. 1 to 6) protruded toward the different space S2 from an end portion of an inner circumference (inner circumference portion 504a) of the annular flat panel portion 504. The grommet 1 is attached to the annular flat panel portion 504 and the annular protruding portion 505 at the circumference portion 503. For example, the insertion target object 501 is formed by pressure molding, and at the time, the annular flat panel portion 504 and the through-hole 502 are formed. Then, in the insertion target object 501, by burring processing on the circumference of the through-hole 502, the annular protruding portion 505 is formed. Thus, in the circumference portion 503, a bent portion 506 bent in such a manner that a bent outer side forms an arc surface 506a is formed between the annular flat panel portion 504 and the annular protruding portion 505 (FIGS. 4 and 6). Here, because the through-hole 502 is formed into a round shape, the annular flat panel portion 504 and the annular protruding portion 505 are each formed into an annular shape.

The grommet 1 includes a base member 10X that causes the wiring member We to be inserted thereinto (FIGS. 1 to 10). The base member 10X may be one member, or may be a plurality of assembled members. The base member 10X illustrated here includes two base members (first base member, second base member) to be assembled to each other. The two base members may be members having different shapes, or may be members having the same shape. In the grommet 1 illustrated here, the same members (base members 10, 10) having the same shape are used as the two base members (FIGS. 1 to 10).

The base member 10X coaxially includes at least an annular flange 20 and a cylindrical portion 30, and causes the wiring member We to be inserted into these (FIGS. 1 to 9). In addition to the flange 20 and the cylindrical portion 30, the base member 10X illustrated here includes a tubular member 40 coaxially with these, and causes the wiring member We to be inserted into these (FIGS. 1 and 3 to 9). Here, the cylindrical portion 30 is coaxially protruded toward one side from the flange 20, and the tubular member 40 is coaxially protruded toward a different side from the flange 20.

In the base member 10X illustrated here, as described later, by the base members 10 and 10 assembled to each other, the annular flange 20, the cylindrical portion 30, and the tubular member 40 are coaxially formed. Thus, a holding mechanism (hereinafter, will be referred to as a “base holding mechanism”.) 50 that holds the two base members 10 and 10 while keeping these in an assembled state is provided between the two base members 10 and 10 (FIGS. 1, 3, 5, and 7 to 9).

In addition, the grommet 1 includes an annular grommet main body 60 to be assembled to the base member 10X (the base members 10 and 10 assembled to each other) (FIGS. 1, 3 to 9, and 11). In order to prevent entry of liquid (water, etc.) into the different space S2 from the one space S1 via the through-hole 502, the grommet main body 60 is arranged in the one space S1 at an attachment completion position of the grommet 1 with respect to the circumference portion 503 (FIG. 4). In addition, hereinafter, in a case where an “attachment completion position” is simply described, the position refers to an attachment completion position of the grommet 1 with respect to the circumference portion 503.

The base members 10X (the base members 10 and 10) are molded using an insulating hard synthetic resin material (hereinafter, will be referred to as “hard resin”). Here, for example, the base member 10X (the base members 10 and 10) are molded using hard resin such as plastic.

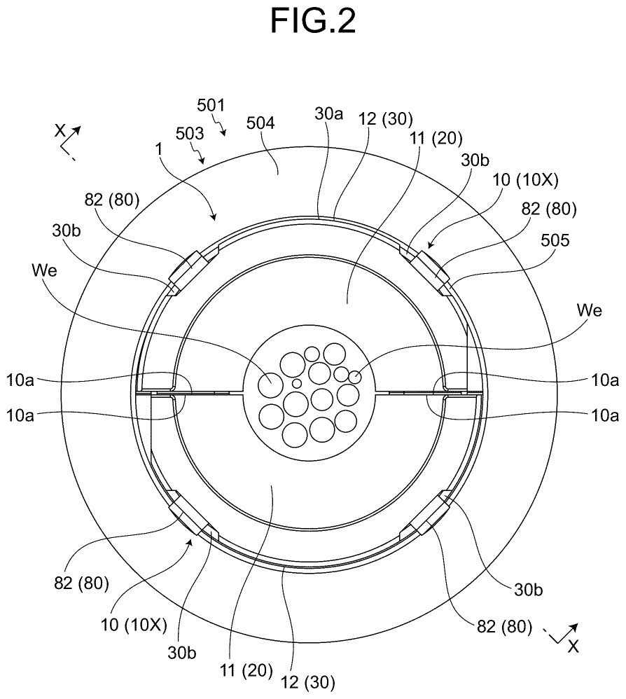

The two base members 10 and 10 assembled by coupling their respective bonded surfaces 10a (FIGS. 2, 3, 7, and 8). The two base members 10 and 10 sandwich the wiring member We with being in the assembled state, and brings the wiring member We into an inserted state. Here, by assembling the two base members 10 and 10, the flange 20 having an annular shape, the cylindrical portion 30 having a cylindrical shape, and the tubular member 40 having a circular tube shape are formed. In addition, here, the tubular member 40 having a straight tube is used as an example. Nevertheless, the tubular member 40 may be bent after being protruded from the flange 20.

The flange 20 is arranged in the one space S1 at the attachment completion position, and is coaxially arranged in such a manner as to face an annular plane 503a on the one space S1 side in the circumference portion 503 with a clearance gap (FIG. 4). The annular plane 503a is provided in the annular flat panel portion 504. The annular plane 503a illustrated here is an annular plane itself on the one space S1 side of the annular flat panel portion 504. The flange 20 is formed into an annular plate shape. For example, the flange 20 is formed into a similar shape to the annular plane 503a having an annular shape. The flange 20 illustrated here arranges its annular outer circumference portion 20a in such a manner as to face the annular plane 503a, and inserts the wiring member We into the inner side of an annular inner circumference portion 20b (FIG. 4). The outer circumference portion 20a is coaxially arranged in such a manner as to face the inner circumference portion 504a side of the annular flat panel portion 504 in the annular plane 503a with a clearance gap in a hole axis direction of the through-hole 502 in the one space S1 (FIG. 4).

The two base members 10 and 10 respectively include divided flanges 11 that form the flange 20 by coupling their respective bonded surfaces 10a (FIGS. 1 to 9). The divided flanges 11 illustrated here are obtained by dividing the flange 20 in half along a central axis, and are formed into a semicircular arcs shape.

The cylindrical portion 30 is coaxially protruded from the flange 20 toward the different space S2, and inserted into the through-hole 502 at the attachment completion position (FIGS. 4 and 6). That is, in the cylindrical portion 30, a leading end protruded from the flange 20 is arranged in the different space S2. The cylindrical portion 30 is formed into a cylindrical shape. For example, the cylindrical portion 30 is formed to have an orthogonal cross-section to a hole axis of the through-hole 502 that is similar-shaped to an orthogonal cross-section to the hole axis of the annular protruding portion 505. The cylindrical portion 30 illustrated here is protruded from the inner circumference portion 20b side of the outer circumference portion 20a in the flange 20, and inserts the wiring member We thereinto (FIGS. 4 and 6).

The two base members 10 and 10 respectively include divided cylinders 12 that form the cylindrical portion 30 by coupling their respective bonded surfaces 10a (FIGS. 2 and 4 to 9). The divided cylinders 12 illustrated here are obtained by dividing the cylindrical portion 30 in half along a central axis, and are formed into a semicircular arcs shape.

The tubular member 40 is coaxially protruded from the flange 20 in a direction opposite to the cylindrical portion 30 (FIGS. 4 to 6). The tubular member 40 is formed into a circular tube shape. For example, the tubular member 40 is formed to have an orthogonal cross-section to a hole axis of the through-hole 502 that is similar-shaped to an orthogonal cross-section to the hole axis of the annular protruding portion 505. The tubular member 40 illustrated here is protruded from the inner circumference portion 20b of the flange 20, and inserts the wiring member We thereinto (FIGS. 4 and 6).

The two base members 10 and 10 respectively include divided tubes 13 that form the tubular member 40 by coupling their respective bonded surfaces 10a (FIGS. 1 and 3 to 9). The divided tube 13 illustrated here are obtained by dividing the tubular member 40 in half along a central axis, and are formed into a semicircular arcs shape.

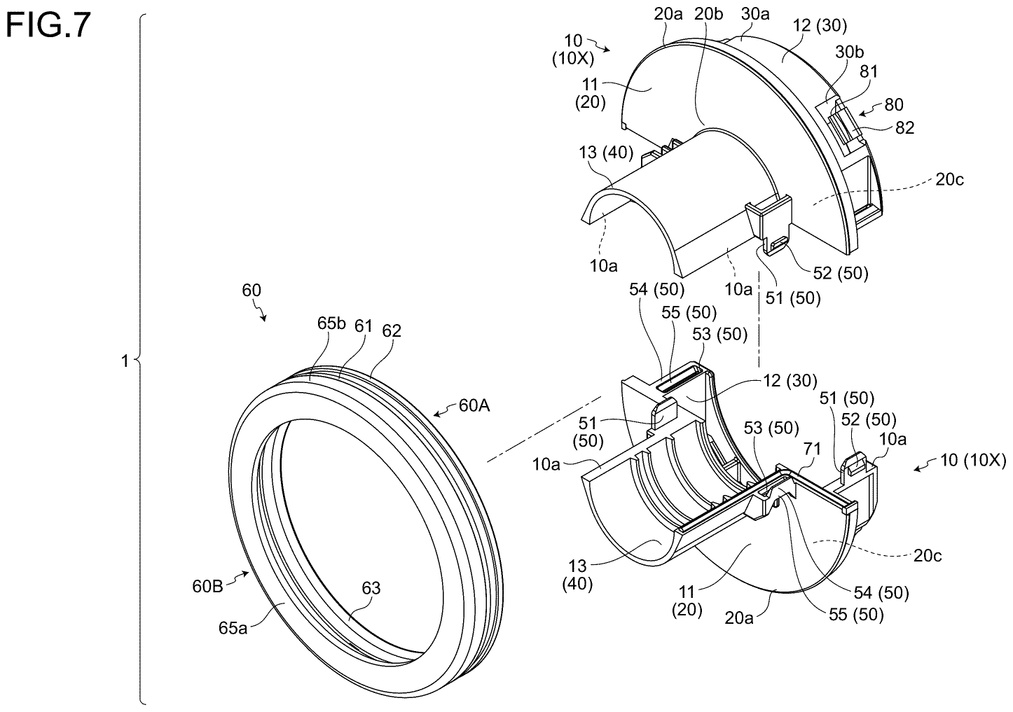

As described above, the two base members 10 and 10 have major portions (the divided flange 11, the divided cylinder 12, the divided tube 13) with high hardness that are less elastically deformable. Thus, the two base members 10 and 10 might form a fine clearance gap attributed to surface roughness or the like of their bonded surfaces 10a, for example, between their bonded surfaces 10a. In view of the foregoing, the grommet 1 of the present embodiment includes a waterproof member 71 that is made of a synthetic resin material (hereinafter, will be referred to as “soft resin”) being elastically deformable and softer than the hard resin of the base member 10, and eliminates a clearance gap between their bonded surfaces 10a, on at least one of their bonded surfaces 10a of the two base members 10 and 10 (FIGS. 7, 8, and 10).

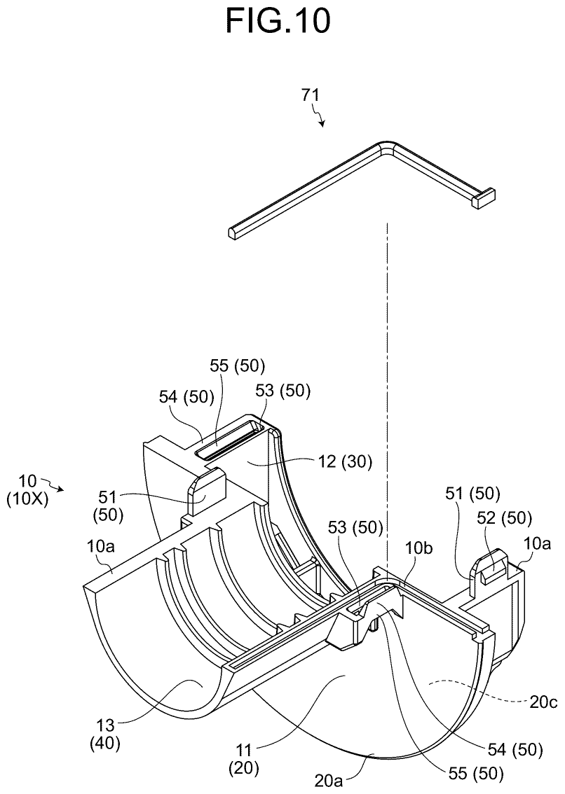

The waterproof member 71 is molded using synthetic resin material such as elastomer, for example. Then, the waterproof member 71 is provided over the bonded surfaces 10a of the divided flanges 11, the divided cylinders 12, and the divided tubes 13, for example. In the base members 10 illustrated here, a groove portion 10b is formed on one of the bonded surfaces 10a at two points from the divided flanges 11 to the divided tubes 13, and the waterproof member 71 is fitted into the groove portion 10b (FIG. 10). The waterproof member 71 is protruded from the groove portion 10b. For example, the waterproof member 71 is molded integrally with the base member 10 by being created by two-color molding with the base member 10, or being subjected to insert molding with respect to the base member 10 fitted in a mold. In addition, the waterproof member 71 is molded as a component different from the base member 10, and may be bonded to the groove portion 10b of the base member 10 using an adhesive or the like. In the base member 10x, by assembling the two base members 10 and 10, the waterproof member 71 protruded from the groove portion 10b of one bonded surface 10a of one base member 10 is brought into close contact with a different bonded surface 10a of a different base member 10.

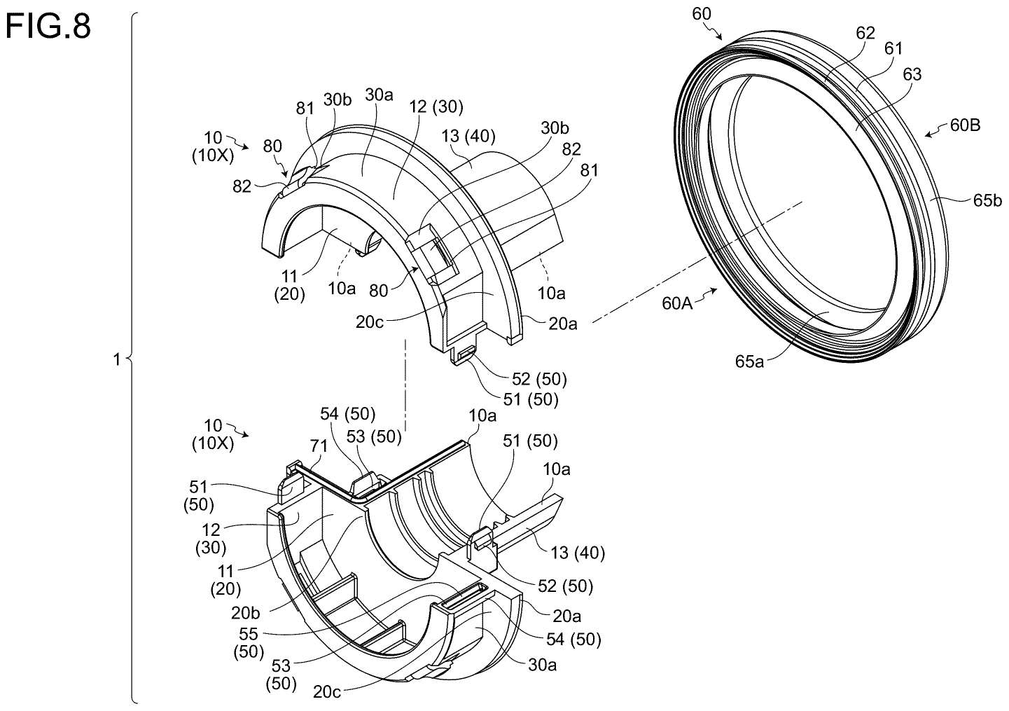

The base holding mechanism 50 is a holding mechanism for holding the respective bonded surfaces 10a of the two base members 10 and 10 in a coupled state. The base holding mechanisms 50 are provided at a plurality of points between the two base members 10 and 10. For example, the base holding mechanism 50 illustrated here includes a piece portion 51 protruded from one bonded surface 10a of the two base members 10 and 10, and a tab-shaped first engagement portion 52 protruded from the wall surface of the piece portion 51 (FIGS. 7 and 8). Then, the base holding mechanism 50 illustrated here includes an insertion port 53 provided on different bonded surface 10a of the two base members 10 and 10, into which one piece portion 51 thereof and the first engagement portion 52 are inserted, a flexible portion 54 that is provided on a different base member 10 of the two base members 10 and 10, and bends by being pressed by the first engagement portion 52 inserted in the insertion port 53, and released from a bent state by the first engagement portion 52 being separated when the respective bonded surfaces 10a are coupled, and a second engagement portion 55 that is provided on the different base member 10 of the two base members 10 and 10, is arranged to face the first engagement portion 52 when the respective bonded surfaces 10a are coupled, and holds the respective bonded surfaces 10a of the two base members 10 and 10 in a coupled state (FIGS. 7 and 8).

The two base members 10 and 10 illustrated here each include one set of the piece portion 51 and the first engagement portion 52 at one end in a circumferential direction of the divided cylinder 12, and one set of the insertion port 53, the flexible portion 54, and the second engagement portion 55 at a different end in the circumferential direction of the divided cylinder 12. In the two base members 10 and 10, in a state in which their bonded surfaces 10a are coupled, the first engagement portion 52 at one end of one divided cylinder 12 and the second engagement portion 55 at a different end of a different divided cylinder 12 are engaged, and the second engagement portion 55 at a different end of the one divided cylinder 12 and the first engagement portion 52 at one end of the different divided cylinder 12 are engaged. That is, in the two base members 10 and 10, the base holding mechanisms 50 that link the respective divided cylinders 12 and hold these in a linked state are provided at two points. Furthermore, the two base members 10 and 10 each include one set of the piece portion 51 and the first engagement portion 52 at one end in a circumferential direction of the divided tube 13, and one set of the insertion port 53, the flexible portion 54, and the second engagement portion 55 at a different end in the circumferential direction of the divided tube 13. In the two base members 10 and 10, in a state in which their bonded surfaces 10a are coupled, the first engagement portion 52 at one end of one divided tube 13 and the second engagement portion 55 at a different end of a different divided tube 13 are engaged, and the second engagement portion 55 at a different end of the divided tube 13 and the first engagement portion 52 at one end of the different divided tube 13 are engaged. That is, in the two base members 10 and 10, the base holding mechanisms 50 that link the respective divided tubes 13 and hold these in a linked state are provided at two points.

The grommet main body 60 includes an annular water stop member 60A made of soft resin (that is, elastically deformable synthetic resin material softer than the hard resin of the base member 10X (the base member 10)), and an annular support member 60B that is made of synthetic resin material harder than the soft resin of the water stop member 60A, and integrated with the water stop member 60A (FIGS. 1, 3 to 8, and 11). The water stop member 60A is molded using synthetic resin material such as an elastically deformable elastomer that is softer than the hard resin of the base member 10X (the base member 10) or the support member 60B, for example. In addition, the support member 60B is made of the same hard resin as the base member 10X (the base member 10) or hard resin that has hardness equivalent to the hard resin of the base member 10X (the base member 10) and is different from the hard resin, for example, and molded using synthetic resin material such as plastic.

The water stop member 60A includes an annular main body 61 that is coaxially brought into contact with an annular wall surface 20c on the circumference portion 503 side of the flange 20 (FIGS. 1, 4, 6 to 8, and 11). The main body 61 is formed into an annular plate shape. The main body 61 illustrated here brings its outer circumference portion 61a into contact with the wall surface 20c of the outer circumference portion 20a of the flange 20 in a state of being protruded from the outer circumference portion 20a of the flange 20 (FIGS. 4 and 6).

Furthermore, the water stop member 60A includes an annular outer circumferential lip 62 that is protruded toward the circumference portion 503 in such a manner as to be separated from the hole axis of the through-hole 502 as coaxially getting closer to the circumference portion 503 from the main body 61, bend-deforms at the attachment completion position, and is brought into close contact with the annular plane 503a of the circumference portion 503 over one circumference, and an annular inner circumferential lip 63 protruded toward the circumference portion 503 in such a manner as to get closer to the hole axis of the through-hole 502 as coaxially getting closer to the circumference portion 503 from an inner circumference portion 61b side than the outer circumferential lip 62 of the main body 61, bend-deforms at the attachment completion position, and is brought into close contact with the annular plane 503a side of the circumference portion 503 over one circumference (FIGS. 1, 3 to 9, and 11).

The outer circumferential lip 62 includes two annular sub lip portions 62b provided on a wall surface 62a on the inner side in a radial direction and coaxially protruded from the wall surface 62a (FIGS. 4 and 6). The outer circumferential lip 62 brings the two sub lip portion 62b into close contact with the annular plane 503a of the circumference portion 503 by bend-deforming from the root on the main body 61 side at the attachment completion position.

In addition, the inner circumferential lip 63 brings a wall surface 63a on an outer side in the radial direction into close contact with the annular plane 503a side of the circumference portion 503 at the attachment completion position (FIG. 4). The inner circumferential lip 63 includes a bend-deformable thin portion 63b on its leading end side (FIGS. 4 and 6). The inner circumferential lip 63 includes the thin portion 63b with a thickness on the leading end side that is made thinner than the thickness of the root on the main body 61 side, and brings the wall surface 63a on the outer side in the radial direction of the thin portion 63b into close contact with the annular plane 503a side of the circumference portion 503 by bend-deforming the thin portion 63b at the attachment completion position. The inner circumferential lip 63 illustrated here may bring the wall surface 63a of the thin portion 63b into close contact with the arc surface 506a of the bent portion 506 of the circumference portion 503 over one circumference, or may bring the wall surface 63a of the thin portion 63b into close contact with the annular plane 503a of the circumference portion 503 over one circumference.

In the grommet main body 60, the water stop member 60A is integrated with the support member 60B. For example, the water stop member 60A is molded integrally with the support member 60B by being created by two-color molding with the support member 60B, or being subjected to insert molding with respect to the support member 60B fitted in a mold. In addition, the water stop member 60A is molded as a component different from the support member 60B, and may be bonded to the support member 60B using an adhesive or the like.

The support member 60B includes an annular portion (hereinafter, will be referred to as a “first annular portion”) 65a coaxially arranged to face an annular contact surface 61c of the main body 61 of the water stop member 60A that contacts the wall surface 20c of the flange 20, with a with a clearance gap (FIGS. 1, 3, 4, 6 to 8, and 11). The first annular portion 65a is formed into an annular plate shape. The base members 10X (the base members 10 and 10 assembled to each other) fit the outer circumference portion 20a of the flange 20 into an annular clearance gap between the contact surface 61c of the main body 61 and the first annular portion 65a. The grommet main body 60 is thereby assembled to be integrated with the outer circumference portion 20a of the flange 20.

In addition, the support member 60B includes an annular portion (hereinafter, will be referred to as a “second annular portion”) 65b that is coaxially protruded toward the outer circumference portion 61a of the main body 61 of the water stop member 60A from an outer circumference portion of the first annular portion 65a, and brought into contact with the outer circumference portion 61a over one circumference (FIGS. 1, 3 to 8, and 11). The second annular portion 65b is formed into an annular plate shape.

The water stop member 60A integrates the outer circumference portion of the first annular portion 65a and the second annular portion 65b in a state of being close contact with their inner wall surfaces, and integrates the outer circumference portion 61a of the main body 61 with a contact surface with the outer circumference portion 61a of the second annular portion 65b in a close contact state. The water stop member 60A includes an annular portion 64 to be integrated in a close contact state with the respective inner wall surfaces of the outer circumference portion of the first annular portion 65a and the second annular portion 65b (FIGS. 4, 6, and 11). The annular portion 64 is formed into a cylindrical shape, and coaxially protruded from the main body 61 in a direction opposite to the outer circumferential lip 62 and the inner circumferential lip 63. For example, in the water stop member 60A, the annular portion 64 is integrally molded in the close contact state with the respective inner wall surfaces of the outer circumference portion of the first annular portion 65a and the second annular portion 65b, and integrally molded in a state in which the main body 61 brings the outer circumference portion 61a into close contact with the contact surface of the second annular portion 65b that contacts the outer circumference portion 61a.

Strictly speaking, the outer circumference portion 20a of the flange 20 is fitted on the inner side of the annular portion 64 of the water stop member 60A in an annular clearance gap between the contact surface 61c of the main body 61 of the water stop member 60A and the first annular portion 65a of the support member 60B. For example, on the inner circumferential surface of the annular portion 64, an annular lip brought into close contact with the outer circumferential surface of the outer circumference portion 20a of the flange 20 over one circumference is formed, which will not be described in detail. The grommet main body 60 thereby ensures waterproof property in the clearance gap between the water stop member 60A and the support member 60B.

The grommet 1 having such a configuration includes a holding mechanism 80 that holds the mutually-assembled base members 10X (the mutually-assembled base members 10 and 10) and the grommet main body 60 at the circumference portion 503 of the through-hole 502 in the insertion target object 501 (FIGS. 2 and 4 to 9). The holding mechanism 80 illustrated here uses elastic force caused by elastic deformation of the outer circumferential lip 62 of the water stop member 60A and the inner circumferential lip 63, and holds the grommet 1 at the circumference portion 503 by sandwiching the circumference portion 503 using the outer circumferential lip 62 and the inner circumferential lip 63, and an engagement portion 81 that is described below and provided on the base member 10X (the base member 10).

The base member 10X includes the engagement portion 81 that is protruded from an outer circumferential surface 30a of the cylindrical portion 30 in the different space S2 at the attachment completion position, and brought into contact with the circumference portion 503 from the different space S2 side in the different space S2 at the attachment completion position (FIGS. 4 to 9). The engagement portion 81 locks a part in the circumferential direction of the circumference portion 503. Therefore, the base member 10X includes a plurality of the engagement portions 81 in the circumferential direction of the cylindrical portion 30.

In addition, the base member 10X includes a cantilevered engagement piece portion 82 having the engagement portion 81 provided at a free end in the different space S2 at the attachment completion position, for each engagement portion 81 (FIGS. 2 and 4 to 9). The engagement piece portion 82 makes a portion protruded toward the one space S1 side from a fixed end on the outer circumferential surface 30a side of the cylindrical portion 30 in the different space S2 at the attachment completion position, a free end, and protrudes the free end side from the outer circumferential surface 30a of the cylindrical portion 30 (default shape). Then, the engagement piece portion 82 is formed to have flexibility that enables bend deformation of changing a protruding amount of the free end side from the outer circumferential surface 30a. By the bend deformation, the engagement piece portion 82 moves in a cutout portion 30b obtained by cutting out a part of the cylindrical portion 30 (FIGS. 2 and 4 to 9). A plurality of sets of a combination of the engagement portion 81, the engagement piece portion 82, and the cutout portion 30b is provided in the cylindrical portion 30 at equal intervals in the circumferential direction. In the cylindrical portion 30 illustrated here, four sets of a combination of the engagement portion 81, the engagement piece portion 82, and the cutout portion 30b is provided at equal intervals in the circumferential direction. Here, two sets of a combination of the engagement portion 81, the engagement piece portion 82, and the cutout portion 30b are provided on the divided cylinder 12 of each base member 10.

When the cylindrical portion 30 is inserted into the through-hole 502 from the one space S1, the engagement piece portion 82 receives force from the annular protruding portion 505 of the circumference portion 503 and bend-deforms toward the cutout portion 30b side from the default shape, passes through the position of the annular protruding portion 505, progresses up to the tip of the leading end (hereinafter, will be referred to as an “engagement end portion”) 505a of the annular protruding portion 505 (FIGS. 4 to 6), and starts to return to the default shape if force received from the annular protruding portion 505 disappears. Thus, the engagement piece portion 82 is arranged at the tip of the engagement end portion 505a of the annular protruding portion 505 together with the engagement portion 81. On the other hand, when a series of movements of the engagement portion 81 and the engagement piece portion 82 are made, the outer circumferential lip 62 and the inner circumferential lip 63 of the water stop member 60A bend-deform by contacting the annular plane 503a side of the circumference portion 503. Therefore, if force for insertion into the through-hole 502 (so-called insertion force) is reduced, the grommet 1 makes a movement of returning toward the one space S1 side, by elastic force caused by elastic deformation of the outer circumferential lip 62 and the inner circumferential lip 63. The engagement portion 81 accordingly contacts the engagement end portion 505a of the annular protruding portion 505, and is locked by the engagement end portion 505a (FIG. 4). That is, the annular protruding portion 505 locks the engagement portion 81 at the leading end (engagement end portion 505a) protruded from the annular flat panel portion 504. At the annular engagement end portion 505a, the engagement portion 81 is locked for each location in the circumferential direction. Accordingly, the circumference portion 503 is nipped by the outer circumferential lip 62 and the inner circumferential lip 63 of the water stop member 60A and each engagement portion 81 of the base member 10X (the base members 10 and 10).

Here, in the grommet 1 of the present embodiment, as described above, the outer circumferential lip 62 is protruded toward the circumference portion 503 in such a manner as to be separated from the hole axis of the through-hole 502 as getting closer to the circumference portion 503, and the inner circumferential lip 63 is protruded toward the circumference portion 503 in such a manner as to get closer to the hole axis of the through-hole 502 as getting closer to the circumference portion 503. Thus, when coming into contact with the annular plane 503a side of the circumference portion 503 while inserting the cylindrical portion 30 into the through-hole 502 from the one space S1, the outer circumferential lip 62 and the inner circumferential lip 63 start bend deformation without being caught by the circumference portion 503. Accordingly, the grommet 1 of the present embodiment can reduce insertion force toward the through-hole 502.

In the grommet according to the present embodiment, when coming into contact with an annular plane side of a circumference portion while inserting a cylindrical portion into a through-hole from one space, an outer circumferential lip and an inner circumferential lip start bend deformation without being caught by this circumference portion. Accordingly, the grommet according to the present embodiment can reduce insertion force toward the through-hole.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A grommet comprising:
a base member that is made of synthetic resin material, and inserts a conductive wiring member laid from one space to a different space through a through-hole of an insertion target object, thereinside; and
an annular grommet main body arranged in the one space at an attachment completion position to a circumference portion of the through-hole of the insertion target object, by being assembled to the base member, wherein
the base member includes an annular flange that is arranged in the one space at the attachment completion position, and coaxially arranged to face an annular plane on the one space side of the annular circumference portion with a clearance gap, and a cylindrical portion coaxially protruded from the flange toward the different space, and inserted into the through-hole at the attachment completion position, and a plurality of engagement portions protruded from an outer circumferential surface of the cylindrical portion in the different space at the attachment completion position, and brought into contact with the circumference portion from the different space side in the different space at the attachment completion position, in a circumferential direction of the cylindrical portion,
the grommet main body includes an annular water stop member made of elastically deformable synthetic resin material softer than the base member,
the water stop member includes an annular main body that is coaxially brought into contact with an annular wall surface on the circumference portion side of the flange, an annular outer circumferential lip that is protruded toward the circumference portion in such a manner as to be separated from a hole axis of the through-hole as coaxially getting closer to the circumference portion from the main body, bend-deforms at the attachment completion position, and is brought into close contact with the annular plane of the circumference portion over one circumference, and an annular inner circumferential lip that is protruded toward the circumference portion in such a manner as to get closer to the hole axis of the through-hole as coaxially getting closer to the circumference portion from an inner circumference portion side than the outer circumferential lip of the main body, bend-deforms at the attachment completion position, and is brought into close contact with the annular plane side of the circumference portion over one circumference, and
the inner circumferential lip includes a bend-deformable thin portion on its leading end side, the thin portion into close contact with the annular plane side of the circumference portion by bend-deforming the thin portion at the attachment completion position.

2. The grommet according to claim 1, wherein
the thin portion bring the wall surface on an outer side in an radial direction into close contact with the annular plane of the circumference portion over one circumference.

3. The grommet according to claim 1, wherein
the circumference portion includes an annular flat panel portion in which the annular plane is provided, and an annular protruding portion that is protruded toward the different space from an end portion of an inner circumference of the annular flat panel portion, and locks the engagement portion at a tip of a protruded leading end.

4. The grommet according to claim 3, wherein
in the circumference portion, a bent portion bent in such a manner that a bent outer side forms an arc surface is formed between the annular flat panel portion and the annular protruding portion, and
the thin portion bring the wall surface an outer side in an radial direction into close contact with the arc surface of the bent portion over one circumference.

5. The grommet according to claim 1, wherein
the grommet main body includes an annular support member that is made of synthetic resin material harder than the water stop member, and integrated with the water stop member,
the support member incudes an annular portion coaxially arranged to face an annular contact surface of the main body that contacts the wall surface of the flange, with a clearance gap, and
the base member fits an outer circumference portion of the flange into the annular clearance gap between the contact surface of the main body and the annular portion.

6. The grommet according to claim 2, wherein
the grommet main body includes an annular support member that is made of synthetic resin material harder than the water stop member, and integrated with the water stop member,
the support member incudes an annular portion coaxially arranged to face an annular contact surface of the main body that contacts the wall surface of the flange, with a clearance gap, and
the base member fits an outer circumference portion of the flange into the annular clearance gap between the contact surface of the main body and the annular portion.

7. The grommet according to claim 3, wherein
the grommet main body includes an annular support member that is made of synthetic resin material harder than the water stop member, and integrated with the water stop member,
the support member incudes an annular portion coaxially arranged to face an annular contact surface of the main body that contacts the wall surface of the flange, with a clearance gap, and
the base member fits an outer circumference portion of the flange into the annular clearance gap between the contact surface of the main body and the annular portion.

8. The grommet according to claim 4, wherein
the grommet main body includes an annular support member that is made of synthetic resin material harder than the water stop member, and integrated with the water stop member,
the support member incudes an annular portion coaxially arranged to face an annular contact surface of the main body that contacts the wall surface of the flange, with a clearance gap, and
the base member fits an outer circumference portion of the flange into the annular clearance gap between the contact surface of the main body and the annular portion.
